(19) United States
(12) Patent Application Publication
(10) Pub. No.: US 2012/0106893 A1
(43) Pub. Date: May 3, 2012

(54) GRATING INSCRIBING IN OPTICAL WAVEGUIDES

(76) Inventors: Raman KASHYAP, Baie d'Urfe (CA); Mathieu GAGNE, Montreal (CA)

(21) Appl. No.: 13/286,335

(22) Filed: Nov. 1, 2011

Related U.S. Application Data
(60) Provisional application No. 61/409,768, filed on Nov. 3, 2010.

(51) Int. Cl. G02B 6/34; C03B 37/10

(52) U.S. Cl. 385/37; 65/392; 65/529

(57) ABSTRACT

There is described herein a method and system for inscribing gratings in optical waveguides. The waveguides may be hydrogen-free, germanium-free, low germanium, low hydrogen, and a combination thereof. Such gratings written in hydrogen-free fibers are suitable for sensor applications in which the use of hydrogen for photosensitizing fibers is undesirable owing to their increased sensitivity to nuclear radiation. The grating are formed by at least one pulse having a wavelength comprised between about 203 nm and about 240 nm. The laser source may be a Continuous Wave (CW) laser source or a pulsed laser source generating at least one pulse having a width in the order of nanoseconds (10⁹).

### CROSS-REFERENCE TO RELATED APPLICATIONS

The present application claims priority under 35 USC 119(e) of U.S. Provisional Patent Application No. 61/409,768, filed on Nov. 3, 2010, the contents of which are hereby incorporated by reference.

### TECHNICAL FIELD

The present invention relates to the field of refractive indexes of optical waveguides, and particularly to modifying an index of refraction by inscribing a grating on a waveguide.

### BACKGROUND

Fiber Bragg gratings (FBGs) are important components for optical telecommunication networks. They also have many applications as sensors. An FBG is a piece of optical fiber in which the refractive index of the fiber core varies periodically. The periodic variation generates a wavelength specific dielectric mirror for reflecting the specific wavelength while propagating any other wavelengths.

Silica glass, from which optical fibers are usually made, has low photosensitivity. Therefore, some optical fibers, such as the standard SMF28™ fiber, are usually hydrogenated before inscribing an FBG thereon. In addition, other dopants may be used to photosensitize the fibers. For example, Boron (B) is a usual dopant added to silica optical fibers for inducing photosensitivity. However, the hydrogenation processes is time-consuming and increases the fabricating costs of FBGs.

### SUMMARY

There is described herein a method and system for inscribing gratings in optical waveguides. The waveguides may be hydrogen-free, germanium-free, low germanium, low hydrogen, and a combination thereof. Such gratings written in hydrogen-free fibers are suitable for sensor applications in which the use of hydrogen for photosensitizing fibers is undesirable owing to their increased sensitivity to nuclear radiation. The grating are formed by at least one pulse having a wavelength comprised between about 203 nm and about 240 nm. The laser source may be a Continuous Wave (CW) laser source or a pulsed laser source generating at least one pulse having a width in the order of nanoseconds (10⁹).

As a result, the fabrication of fiber Bragg gratings is possible using a nanosecond Q-switched Nd:VO4 laser fifth harmonic (213 nm) source. This laser operating at a wavelength of 213 nm enables the writing of strong gratings in numerous fibers, including standard telecommunications SMF28™ without the use of hydrogen. This laser source is very convenient compared to the alternative of pulsed excimer lasers, which are difficult to use, require care in handling of toxic gasses as well as continuous maintenance. 213 nm pulses having a pulse width of 7 ns are suitable for writing FBGs in optical fibers, and particularly in hydrogen-free fibers. The value for the pulse width may vary as along it is adapted to photosensitize the optical fiber via a single-photon absorption process. In one embodiment, the photosensitivity induced by the 213 nm pulsed light is due to short-lived defects. In this case, an adequate pulse width adapted to modify the refractive index of the optical fiber via a single-photon absorption process corresponds to a pulse width substantially equal to or greater than the lifetime of the short-lived defects.

According to a first aspect, there is provided a method for inscribing a grating into an optical waveguide, the method comprising: generating a light beam having a wavelength comprised between about 203 nm and about 240 nm, the light beam comprising at least one output pulse having a pulse width of an order of magnitude of nanoseconds (10⁻⁹); directing the light beam onto an optical waveguide transversely to a propagation axis thereof; and changing an index of refraction of the optical waveguide as a function of an intensity and a duration of the light beam.

According to another broad aspect, there is provided method for inscribing a grating into an optical waveguide, the method comprising: generating a light beam having a wavelength comprised between about 203 nm and about 240 nm, the light beam comprising one of a continuous wave output beam and at least one output pulse having a pulse width of an order of magnitude of nanoseconds (10⁻⁹); directing the light beam onto an optical waveguide transversely to a propagation axis thereof; and changing an index of refraction of the optical waveguide as a function of an intensity and a duration of the light beam.

According to another broad aspect, there is provided a system for inscribing a grating into an optical waveguide, the system comprising: a pulsed light source for generating and emitting an output beam having a wavelength comprised between about 203 nm and about 240 nm, the output beam comprising at least one output pulse having a pulse width of an order of magnitude of nanoseconds (10⁻⁹); and a directing device for directing the output beam onto an optical waveguide transversely to a propagation axis thereof and changing an index of refraction of the optical waveguide as a function of an intensity and a duration of the output beam.

According to yet another broad aspect, there is provided an optical filter comprising an optical waveguide extending along a propagation axis thereof, the optical waveguide having a grating formed therein causing an index of refraction to vary along the propagation axis, the grating having been formed by at least one pulse having a wavelength comprised between about 203 nm and about 240 nm and a pulse width of an order of magnitude of nanoseconds (10⁻⁹).

For the purposes of the present description, the expression “an order of magnitude of nanoseconds (10⁻⁹)” should be understood to mean a pulse width greater than or equal to 1 nanosecond. In some embodiments, the pulse width is between 1 nanosecond and 20 nanoseconds. In some embodiments, the pulse width is between 1 nanosecond and 12 nanseconds. In some embodiments, the pulse width is between 5 nanoseconds and 12 nanoseconds. In some embodiments, the pulse width is between 7 nanoseconds and 12 nanoseconds. In some embodiments, the pulse width is between 7 nanoseconds and 10 nanoseconds. In some embodiments, the pulse width is between 12 nanoseconds and CW. The expression “continuous wave output beam” should be understood to mean a beam having constant amplitude and frequency.

### BRIEF DESCRIPTION OF THE DRAWINGS

FIG. 1A is a block diagram of an exemplary system for inscribing a fiber Bragg grating into an optical waveguide, in accordance with a first embodiment;

FIG. 1B is a block diagram of the system of FIG. 1 using a focusing device, as per one embodiment;

FIG. 1C is a block diagram of the system of FIG. 1 using an interfered pulsed light, as per another embodiment;

FIG. 2A is a flow chart of a method for changing an index of refraction of an optical waveguide using the system of FIG. 1B, in accordance with a embodiment;

FIG. 2B is a flow chart of a method for changing an index of refraction of an optical waveguide using the system of FIG. 1C, in accordance with a second embodiment;

FIG. 3 illustrates a system for inscribing FBGs in an optical fiber using a phase mask, in accordance with an embodiment;

FIG. 4 is an exemplary graph of the reflectivity of an FBG inscribed in a hydrogen-free SMF28™ fiber using a 7 ns Q-switched 266 nm source with 600 mW average power and an exposure time of 20 minutes;

FIG. 5 is an exemplary graph of the reflectivity of an FBG inscribed in a hydrogen-free SMF28™ fiber using a 213 nm source with 35 mW power and an exposure time of 10 minutes;

FIG. 6 is an exemplary graph of the reflection and a refractive index modulation versus an exposure time for the FBG of FIG. 5;

FIG. 7 is an exemplary graph of a transmission and a refractive index modulation as a function of an exposure time for a FBG inscribed in a Redfern™ fiber using a 266 nm source with 65 mW power;

FIG. 8 is an exemplary graph of a reflectivity versus a wavelength of a FBG inscribed in a Redfern™ fiber using a 213 nm source with 59 mW power and an exposure time of 3 minutes;

FIG. 9 is an exemplary graph of a transmission and a refractive index modulation as a function of an exposure time for the FBG of FIG. 8;

FIG. 10 is an exemplary graph of a refractive index modulation as a function of an exposure time for a FBG inscribed in a Redfern™ fiber using a 266 nm source, a FBG inscribed in a Coractive™ fiber using a 213 nm source, and a FBG inscribed in a Redfern™ fiber using the 213 nm source;

FIG. 11 is an exemplary graph of a transmission and a refractive index modulation as a function of an exposure time for a FBG inscribed in a Redfern™ fiber using a 213 nm source with a power 110 mW;

FIG. 12 is an exemplary graph of a transmission as a function of a wavelength for the FBG of FIG. 11;

FIG. 13 is an exemplary graph of a transmission as a function of a wavelength for a FBG inscribed in a SMF28™ fiber using a 213 nm source with 110 mW power and an exposure time of about one hour;

FIG. 14 is an exemplary graph of a transmission and a refractive index modulation as a function of an exposure time for a FBG inscribed in a SMF28™ fiber using a 213 nm source with 110 mW power.

FIG. 15 illustrates a transmission as a function of wavelength for an FBG inscribed in an SMF28™ fiber using a 213 nm source with 110 mW power and an exposure time of about two hours;

FIG. 16 is an exemplary graph of a transmission as a function of wavelength for a Type IIA FBG inscribed in a Redfern™ fiber;

FIG. 17 is an exemplary graph of an index modulation as a function of exposure time in an FBG inscribed in a Redfern™ fiber using a 213 nm source with three different powers;

FIG. 18 is an exemplary log-log graph of an initial growth rate of a refractive index change versus for the FBG of FIG. 17 and an FBG inscribed in a SMF28™ fiber using a 213 nm source;

FIG. 19 is an exemplary graph of a transmission versus wavelength for a 2.7 mm type IIA FBG written in a Redfern™ fiber;

FIG. 20 is an exemplary graph of an index modulation as a function of an exposure time in a FBG inscribed in a SMF28™ fiber using a 213 nm source with three different powers;

FIG. 21 is an exemplary graph of a transmission versus wavelength for the FBG of FIG. 20;

FIG. 22 is an exemplary graph of a transmission versus an exposure time for a FBG inscribed in a CorActive™ Er-doped polarization maintaining fiber;

FIG. 23 is an exemplary graph of transmission versus wavelength for the FBG of FIG. 22;

FIG. 24 is an exemplary emission spectrum of a laser comprising two FBGs written in a CorActive™ Er-doped polarization maintaining fiber; and

FIG. 25 is an exemplary graph of a reflection versus a wavelength for a 5 mm FBG inscribed in a pure silica fiber using a 213 nm source with a power of 90 mW and an exposure time of 90 minutes.

### DETAILED DESCRIPTION

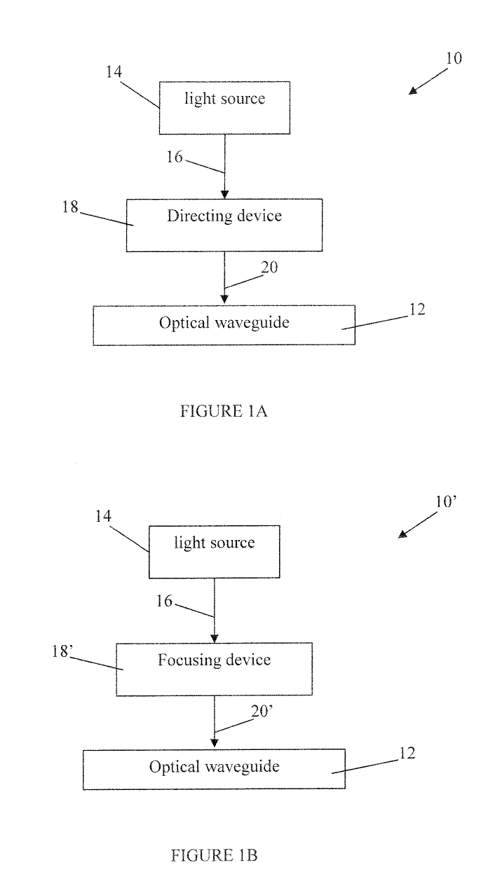

FIG. 1A illustrates one embodiment of a system 10 for changing the index of refraction of an optical waveguide 12. The system comprises a pulsed light source 14 for generating a pulsed light 16 having a wavelength comprised between about 203 nm and about 240 nm, and a pulse width set for photosensitizing the optical fiber via a single-photon absorption process. The system 10 further comprises a directing device 18 for directing the pulsed light 16 on the optical waveguide 12 by propagating a directed beam 20 into the optical waveguide 12 transversely to a propagation axis of the optical waveguide.

In one embodiment, illustrated in FIG. 1b, the directing device 18 corresponds to a focusing device 18′, such as at least one lens, for focusing the pulsed light beam 16 on a particular region of the optical waveguide in order to induce a local change of refractive index. In this case, the system 10′ may be adapted to inscribe a periodic change of refractive index into the optical waveguide 12 to form a grating therein using a point-by-point writing technique. For example, the optical waveguide 12 may be secured to a mounting device movable with respect to the focusing device 18′. In another embodiment, the focusing device 18′ may be movable with respect to the optical waveguide 12. The focusing device 18′ propagates a focused beam 20′ onto the optical waveguide 12.

In another embodiment, illustrated in FIG. 1c, the directing device 18 is an interference pattern generator 18″ adapted to generate an optical interference pattern for inscribing a grating into the optical waveguide 12. The system 10″ comprises a pulsed light source 14 adapted to emit a pulsed light 16, and an interference pattern generator 18″. The pulsed light 16 has a wavelength comprised between about 203 nm and about 240 nm and comprises pulses of which the pulse width is chosen to be adapted to modify the refractive index of the optical waveguide via a single-photon absorption process.

The pulsed light beam 16 is propagated into the interference pattern generator 18″ adapted to generate an optical interference pattern 20″ by interfering the incident pulsed light 16. The optical waveguide 12 is positioned so as to be exposed to the optical interference pattern 20″ which generates a periodic variation in the index of refraction of the optical waveguide 12, thereby generating a Bragg grating therein. The characteristics of the optical interference pattern 20″ are chosen as a function of parameters such as the wavelength of the incoming pulsed light 16, a desired reflection wavelength for the FBG to be inscribed and the like.

For systems 10, 10′, and 10″, the repetition rate of the pulsed light source 14 and the peak pulse power for the pulses of the pulsed light 16 are chosen as a function of desired characteristics such as a desired reflectivity for the Bragg grating to be inscribed, an inscription time duration, and the like.

It should be understood that the optical waveguide 12 may have any adequate chemical composition as along as it can guide light therein. For example, the optical waveguide 12 can be made at least partially from silica glass. For example, the optical waveguide can be made from substantially pure silica glass. It should be understood that the optical waveguide can be made from any adequate material other than silica glass such as fluoride glass, phosphate glass, chalcogenide glass, and the like. In another embodiment, the optical waveguide 12 can also comprise dopants such as Germanium (GE), Boron (B), Nitrogen (N), and the like.

The interference pattern generator 18″ can be any adequate system or device adapted to interfere an incident light and generate an optical interference pattern. For example, the interference pattern generator 18″ can be a phase mask adapted to the wavelength of the pulsed light 16. In another embodiment, the optical interference generator 18″ is an interferometer. Examples of adequate interferometers comprise an amplitude-splitting interferometer such as a Talbot interferometer, a wavefront-splitting interferometer such as a phase-mask, a prism interferometer or a Lloyd interferometer, and the like.

It should be understood that the Bragg grating inscribed in the optical waveguide 12 may be any type of Bragg grating. For example, the Bragg grating may have a fixed period. Other examples of adequate Bragg gratings include chirped Bragg gratings, tilted Bragg gratings, and the like.

The optical waveguide 12 may be any type of optical waveguide. For example, the optical waveguide 12 may be doped with dopants such Ge, B, N, and the like. It should be understood that the quantity of dopant within the optical waveguide 12 may vary. For example, the optical waveguide 12 may have a low Ge-content such as a 3% Ge-content. In another example, the optical waveguide 12 may have a high dopant-content. In one embodiment, the optical waveguide 12 may be hydrogen-free, i.e. the optical waveguide has not been hydrogenated before the inscription of the FBG so that substantially no hydrogen is contained in the optical waveguide 12.

In one embodiment, the optical waveguide 12 is an optical fiber comprising a core extending along a longitudinal axis and surrounded by a cladding. For example, the optical fiber can be a pure silica core fiber. Other examples of suitable optical fibers comprise low dopant-content fibers such as low Ge-content fibers, high dopant-content fibers such as high Ge-content fibers, hydrogen-free fibers, hydrogenated fibers, and the like.

In another embodiment, the optical waveguide 12 is a planar waveguide. In a further embodiment, the optical waveguide 12 is in a bulk crystal. In still a further embodiment, the refractive index change or the grating is inscribed in a bulk crystal.

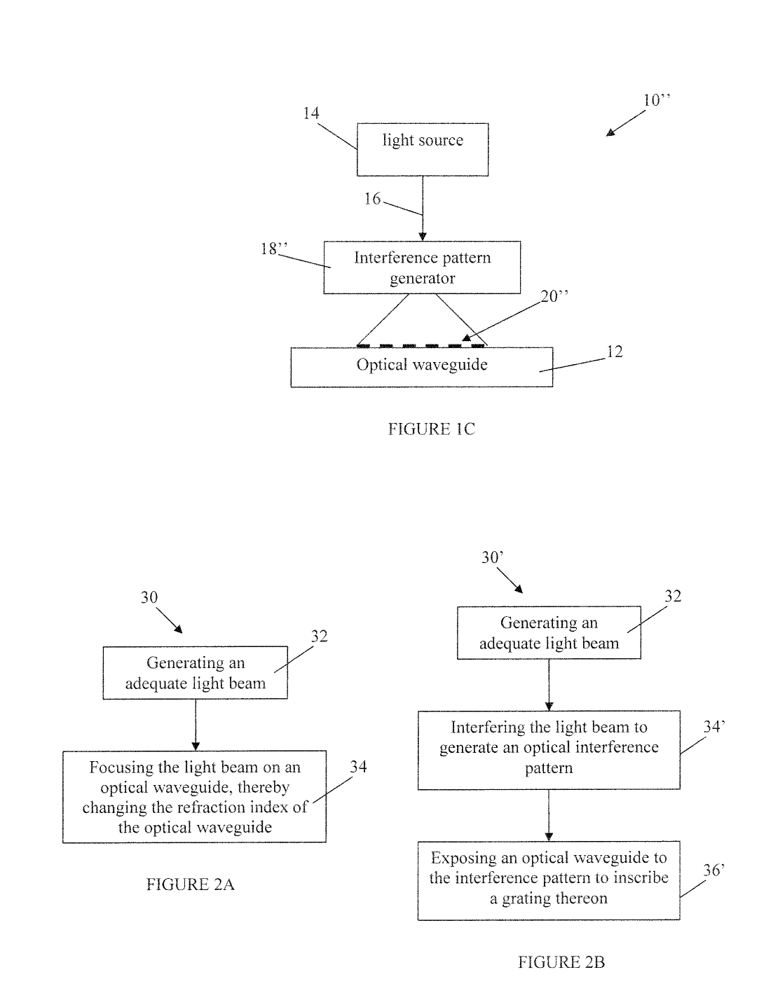

FIG. 2a illustrates one method 30 for inscribing an FBG in an optical waveguide, using the system of FIG. 1b. At step 32, a pulsed light having a wavelength comprised between about 203 nm and about 240 nm is generated. The pulsed light comprises at least one pulse having a given pulse width. At step 34, the pulsed light is focused on the optical waveguide transversely to the propagation axis of the optical waveguide. The given pulse width is adapted to modify the index of refraction of the optical waveguide via a single-photon absorption process. It should be understood that the focusing of the pulsed light on the optical waveguide can be achieved using any adequate focusing device. For example, the focusing device can comprise at least one lens. In another example, the focusing device may be a interference pattern generator.

FIG. 2b illustrates one embodiment of a method 30′ for inscribing a Bragg grating in an optical waveguide using the system of FIG. 1c. The first step 32 comprises generating a pulsed light 16 having a wavelength comprised between about 203 nm and about 240 nm and comprising pulses of which the pulse width is chosen to be adapted to modify the refractive index of the optical waveguide via a single-photon absorption process. The second step 34′ comprises interfering the pulsed light in order to generate an optical interference pattern adequate for the FBG to be inscribed to reflect a desired wavelength. Any adequate interference pattern generator as described above may be used for generating the optical interference pattern. For example, the generated pulsed light may be directed to illuminate a phase mask. In this case, the phase mask is designed as function of parameters such as the wavelength of the generated pulsed light, a desired reflecting wavelength for the FBG, and the like. At step 36′, the optical waveguide is positioned so as to be illuminated by the optical interference pattern, thereby inscribing the Bragg grating having the desired reflection wavelength in the optical waveguide.

While the present description refers to the inscription of a Bragg grating, it should be understood that other grating may be inscribed in an optical waveguide using the system 10 and/or the method 30. For example, long-period gratings may be inscribed in optical waveguides.

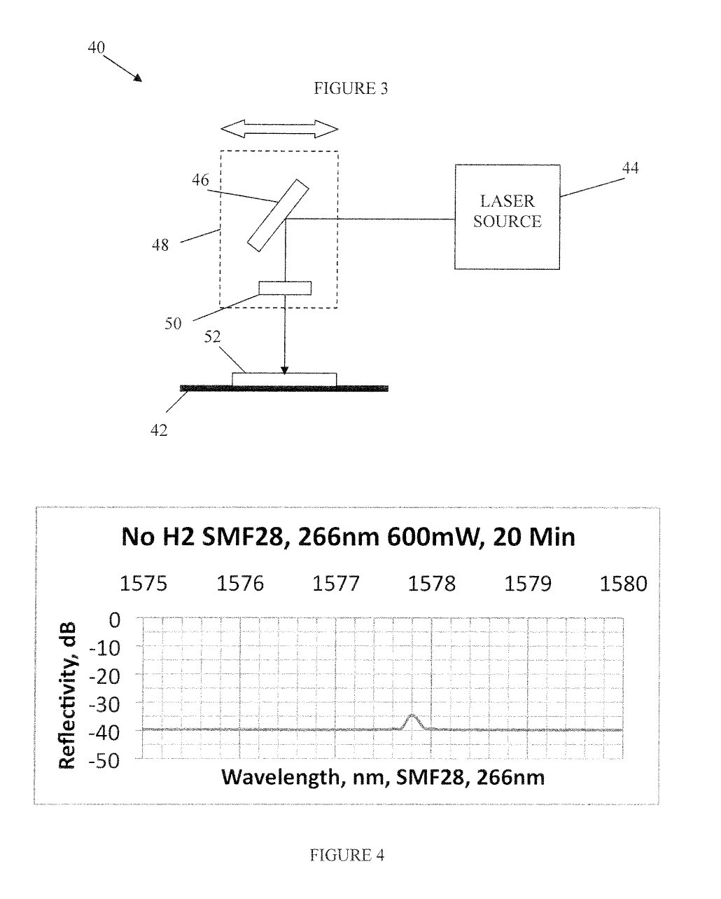

FIG. 3 illustrates one embodiment of a system 40 for inscribing an FBG in an optical fiber 42. The system comprises a pulsed laser source 44, a mirror 46, a motorized translation stage 48, a cylindrical lens 50, and a phase mask 52. The mirror 46 is mounted to the motorized translation stage 48 of which the position and displacement speed is controlled by a controller (not shown). The pulsed laser 44 emits a pulsed light which is reflected by the mirror 46 towards the cylindrical lens 50. The cylindrical lens 50 focalizes the incoming beam of pulsed light onto the phase mask 52. By displacing the mirror 46 using the motorized stage 48, it is possible to uniformly scan the phase mask 52 and the optical fiber 42, and inscribe an FBG over a given length for the optical fiber 42.

In one embodiment the pulsed laser source 44 is an XVL-5HG nanosecond quintupled Nd:YAG laser emitting light at 213 nm and producing 7 ns and 10 μJ pulses at a frequency or repetition rate adjustable between 0.1-30 kHz. The 7 ns pulse width is adequate to modify the refractive index of the optical fiber 42 via a single-photon absorption process. The maximum average power of the laser was measured to be at least 120 mW. The beam has a diameter of approximately 1 mm and exhibits a Gaussian profile. The phase mask 52 is designed for 209 nm. Since the phase mask 52 is not designed exactly for 213 nm, a certain portion of the power is present in the zero^{th} order as well as in the higher orders, inducing a small additional DC component in the index variation. This small difference between the design wavelength of the phase mask 52 and the actual laser wavelength may not be critical, but may affect the maximum FBG reflectivity that can be achieved with this configuration. The zero^{th} order power is expected to represent at most about 1% of the incoming power.

In one embodiment, the fiber 42 is scanned at a constant speed of 1 mm/s over an 8 mm length. The cylindrical lens 50 is a 20 cm focal length cylindrical CaF2 lens which is adequate for 213 nm light. The laser 44 operates at a frequency of 12.5 kHz. These experimental conditions lead to adequate averaging of the index modulation while avoiding damage or thermal effects which may be critical for the fabrication of FBGs.

The following presents experimental results obtained while inscribing FBGs in three different fibers, i.e. an SMF28™, a CorActiveEVS™ fiber, and a B/Ge doped Redfern™ photosensitive (PS) fiber, using the experimental set-up of FIG. 3 and the above described experimental conditions. No hydrogenation was used to photosensitize the fibers. The time of exposure was either to a saturated index change, or until bleaching of the grating was observed. The gratings were written by scanning the fiber continuously over a length of 21 mm but exposed only over 8 mm.

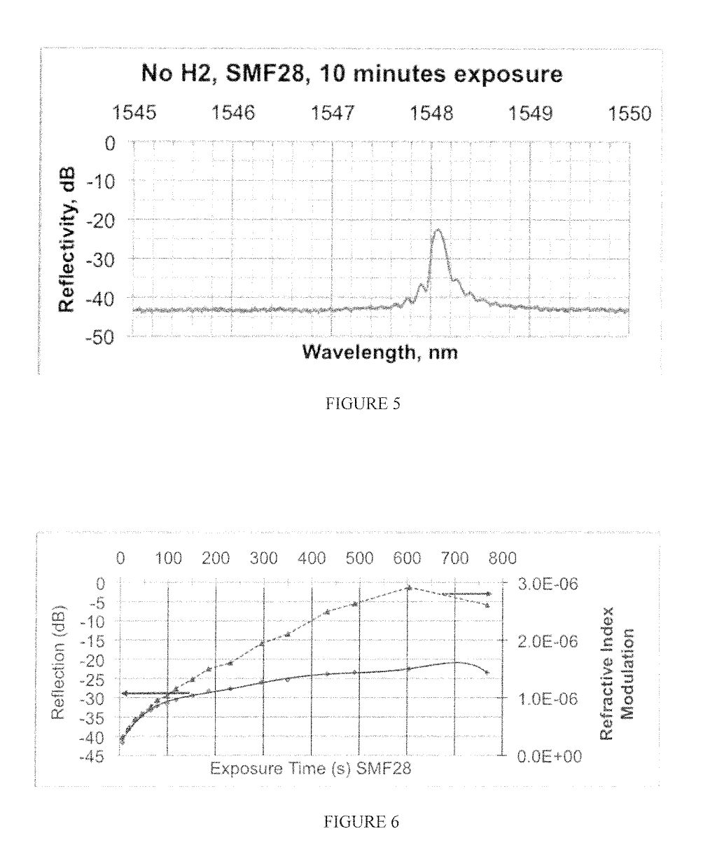

In order to compare the FBGs obtained using the system of FIG. 3, reference FBGs were inscribed using a 7 ns 266 nm Q-switched (QS) source in the same three optical fibers. FIG. 4 illustrates the reflectivity of an FBG inscribed in a hydrogen-free SMF28™ fiber using the 266 nm source with 600 mW average power and an exposure time of 20 minutes. The FBG of FIG. 4 has a maximum reflectivity of less than 0.05%. FIG. 5 illustrates the reflectivity of an FBG inscribed in a hydrogen-free SMF28™ fiber using the 213 nm source with 35 mW power and an exposure time of 10 minutes. FIG. 6 illustrates both the reflectivity and the refractive index modulation as a function of the exposure time for the FBG of FIG. 5. The FBG of FIG. 5 has a maximum reflectivity of about 0.5%. Using the 266 nm source and an exposure time of 10 minutes, substantially no FBG is detected in the hydrogen-free SMF28™ fiber.

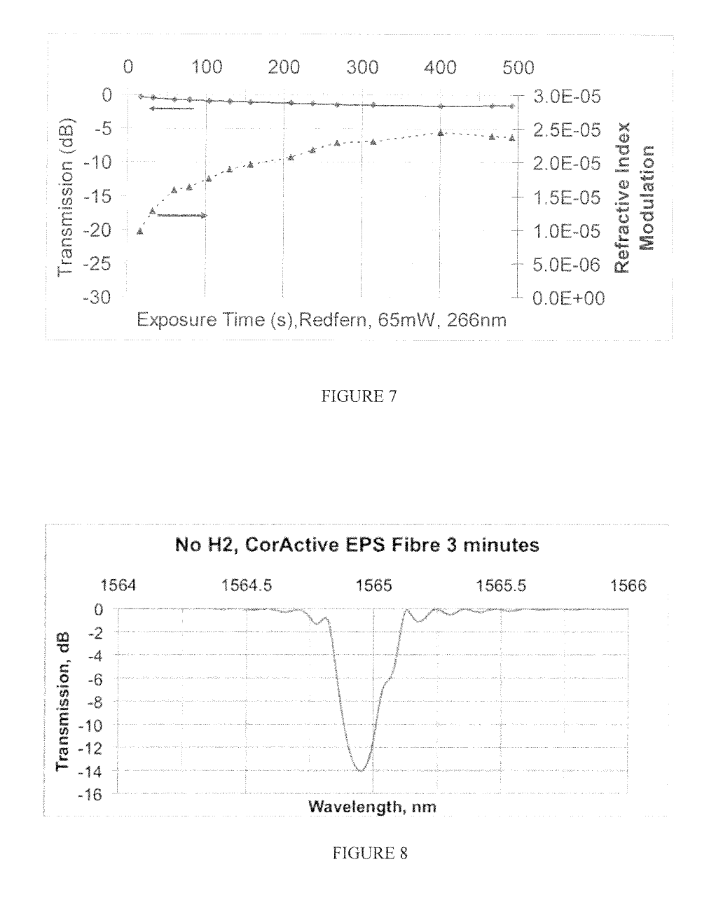

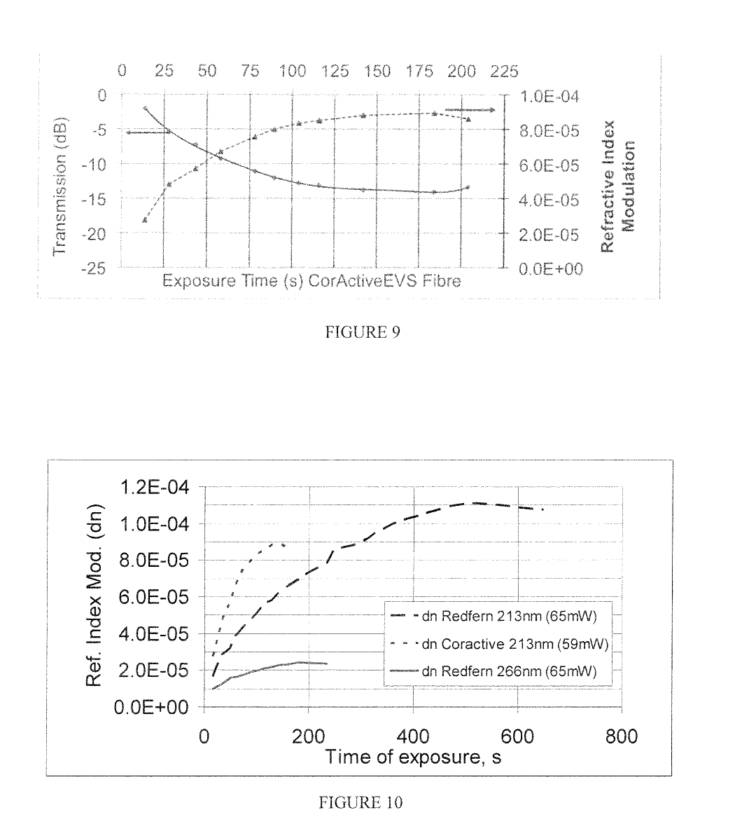

FIG. 7 illustrates the transmission and refractive index modulation as a function of the exposure time for an FBG inscribed in a Redfern™ fiber using the 266 nm source with 65 mW power. FIG. 8 illustrates the reflectivity of an FBG inscribed in the Redfern™ fiber using the 213 nm source with 59 mW power and an exposure time of 3 minutes. FIG. 9 illustrates the transmission and refractive index modulation as a function of the exposure time for an FBG inscribed in a Redfern™ fiber using the 213 nm source with 59 mW power and an exposure time of 3 minutes. Approximately 2 mW of 213 nm laser power was sufficient to observe a reflectivity of about −20 dB (about 1%) in a 5 mm long FBG in the Redfern™ fiber for an exposure time of 20 minutes.

FIG. 10 shows the growth of the UV exposure induced refractive index change in two fibers, i.e. the Redfern™ fiber and the Coractive™ fiber, with 213 nm and 266 nm exposure. The 213 nm laser power was between 59 mW and 65 mW, whereas the 266 nm power was 65 mW, again with a repetition rate of 15 kHz. The lengths of the gratings were fixed to 8 mm and the exposure conditions were substantially identical. At 266 nm, the grating in the Redfern™ fiber has an induced refractive index change 5 times less than with 213 nm exposure using of 65 mW. The grating saturates faster with 266 nm exposure at around 200 seconds, whereas it continues to grow with 213 nm (65 mW) exposure for about 600 seconds in Redfern™ fiber. The maximum refractive index change is about 1.5e-4 and about 0.22e-4 for 213 nm and 266 nm exposure, respectively.

As a result, 266 nm wavelength radiation requires several 100's of mW to inscribe gratings in the Redfern™ or CorActive™ fibers. Virtually no reflection (0.03%), is visible in SMF28 fiber for an 8 mm long grating with 600 mW of 266 nm radiation compared to a healthy 0.5% reflection with the 213 nm source. Assuming that the 266 nm radiation with 300 mW power induces a maximum of 0.5% grating in SMF28, the sensitivity of the fiber to 213 nm radiation is at least an order of magnitude greater than with 266 nm radiation (35 mW of 213 nm compared to 600 mW of 266 nm). In addition, no hydrogenation was required for any of the three fibers tested to observe reflections. Certainly, the Redfern™ and the CorActive™ fibers show an excellent response to 213 nm radiation even without hydrogen. With higher powers such as 200 mW for example, the photosensitivity of these fibers as well as SMF28 could be excellent on two counts: (1) speed of writing, and (2) strength of grating obtained. Comparison of the photosensitivity shows that the 213 nm exposure is at least 5 times greater for FBG inscription in hydrogen-free fibers.

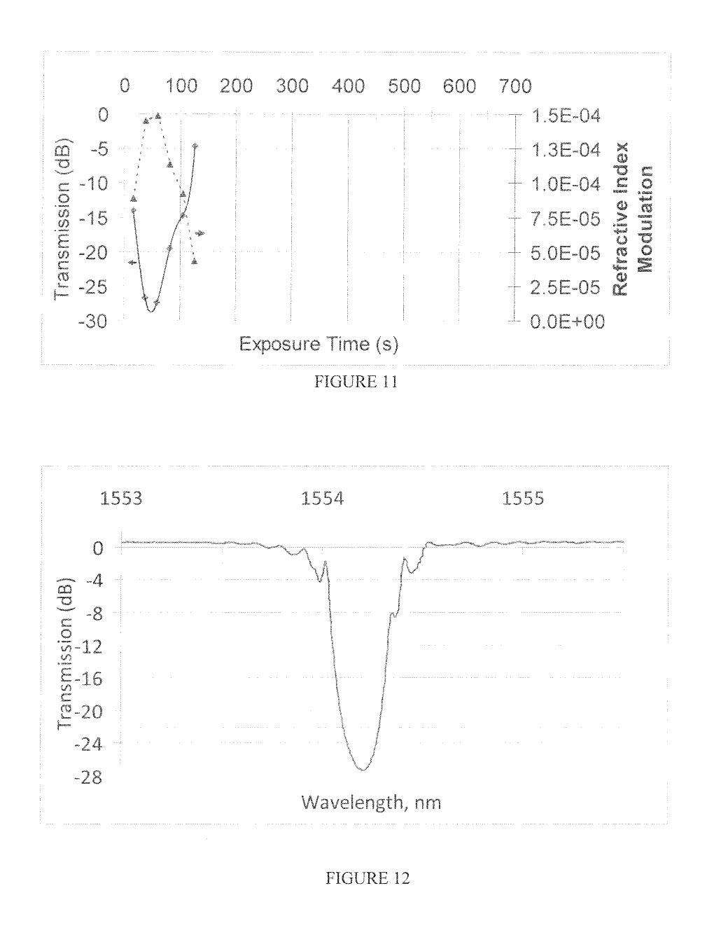

FBGs were inscribed in the Redfern™ fiber and the SMF28™ fiber using the 213 nm light source with 110 mW power. FIG. 11 illustrates the transmission and the refractive index modulation as a function of the exposure time for an FBG inscribed in the Redfern™ fiber using the 213 nm source with a power of 110 mW. FIG. 12 illustrates the transmission as a function of wavelength for the FBG inscribed in the Redfern™ fiber using the 213 nm source with the 110 mW power.

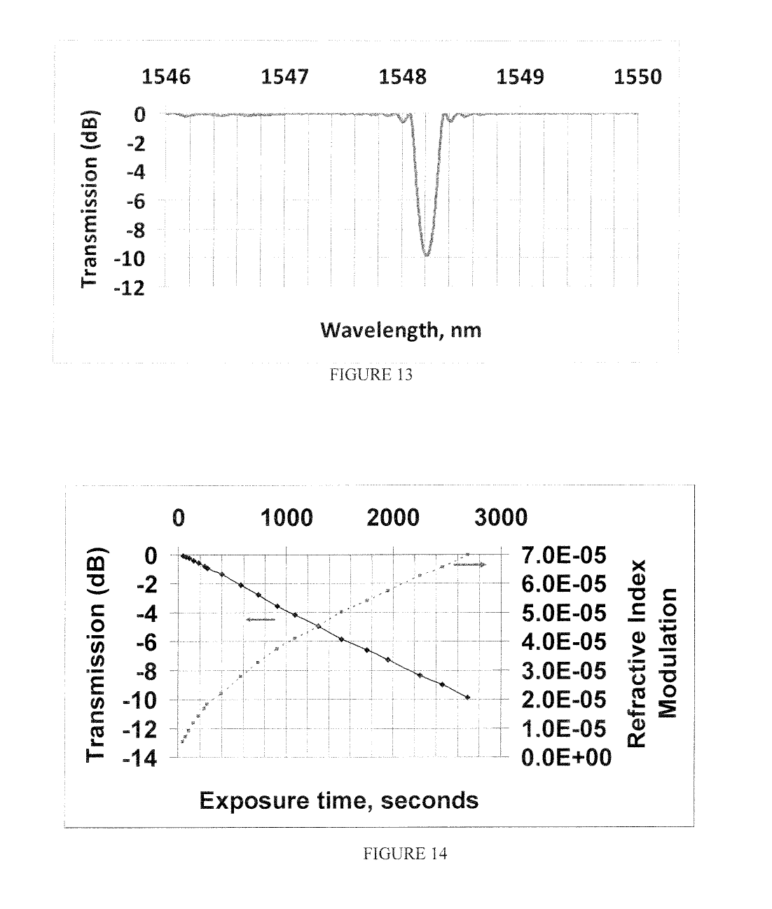

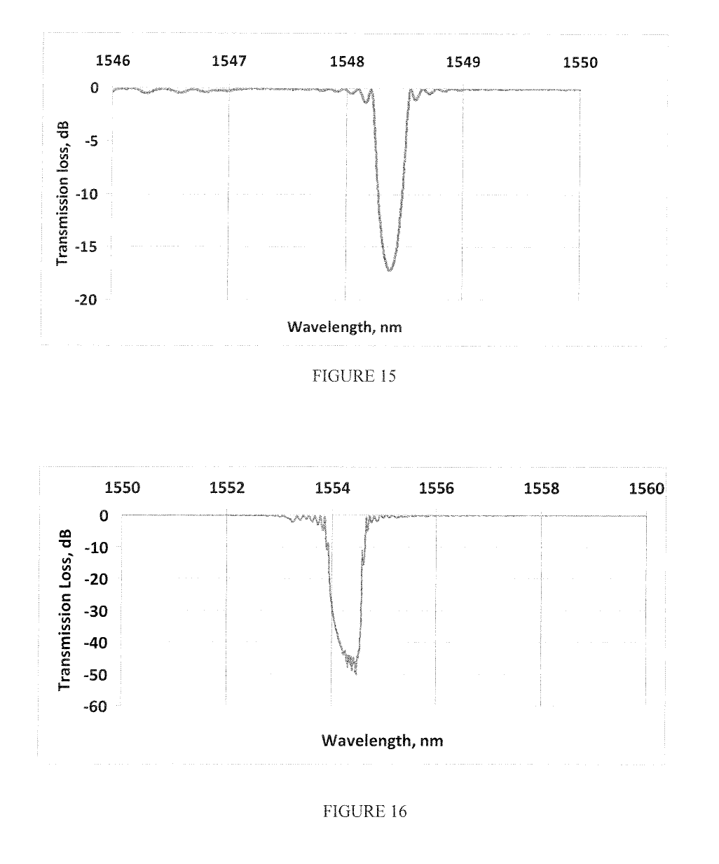

FIG. 13 illustrates the transmission as a function wavelength for an FBG inscribed in the SMF28™ fiber using the 213 nm source with the 110 mW power and an exposure time of about one hour. FIG. 13 shows that the resulting FBG has a reflectivity of about 90%. FIG. 14 illustrates the transmission and the refractive index modulation as a function of the exposure time for an FBG inscribed in the SMF28™ fiber using the 213 nm source with a power of 110 mW. FIG. 15 illustrates the transmission as a function of wavelength for an FBG inscribed in the SMF28™ fiber using the 213 nm source with the 110 mW power and an exposure time of about two hours. After two hours of exposure the 213 nm light, the FBG has a reflectivity of about 17 dB, i.e. about 98%.

TYPE IIA gratings: A Redfern™ fiber was exposed after better alignment with a power of 100 mw. FIG. 16 illustrates the transmission spectrum of the resulting FBG. This resulting FBG is a Type IIA grating which emerges after bleaching. The transmission loss indicates a peak reflection of at least 99.999%. The grating length was 8 mm.

Comparison of the three tested fibers: In the case of SMF28™ fiber, 600 mW of 266 nm radiation only produced an almost measurable grating in reflection as illustrated in FIG. 4. 110 mW of 213 nm radiation produces a grating which is 90% in one hour and continues to grow in strength on what appears to be a linear slope to 98% in two hours.

The gratings written into the Redfern™ fiber with 110 mW of 213 nm radiation reaches 28 dB, i.e. a reflectivity of about 99.8%, in 50 seconds, showing a great photosensitive response by the increase in the writing power (from 65 mW). After 50 seconds of exposure, the grating bleaches rapidly as it turns into a Type 2A in hydrogen-free fiber. FIG. 16 shows the grating re-grown after bleaching to form a Type IIA grating. The reflectivity of this grating is superior to 99.999%. The time of exposure was 55 seconds.

As a result, 213 nm radiation with an adequate pulse width, i.e. 7 ns, enables the writing of gratings in the three tested fibers, including the standard SMF28™ fiber without the use of hydrogen loading. Even for type IIA gratings, the end results are stronger gratings of great quality, which demonstrates the versatility of the system of FIG. 3.

The peak power in the pulse using the 213 nm laser is calculated to be only about 700 W. The power density in the focused beam is estimated to be about 35 MW-cm². We therefore believe that the use of about 1 W of CW radiation from a 213 nm laser may induce much stronger gratings and also suffice, under certain circumstances (such as for a low Ge-content fiber), for inscribing high quality gratings in hydrogen-free fibers.

The following presents further experimental results obtained using the experimental set-up of FIG. 3. Strong FBGs in hydrogen-free fibers, including the SMF28™ fiber were obtained using the 213 nm ns pulse QS radiation, with a low intensity of about 3 MW-cm⁻² and an average power of about 100 mW. The FBGs were written in the Redfern™ B/Ge-doped and standard Corning™ SMF28™ fibers. Strong gratings are shown to be obtained rapidly in seconds in hydrogen-free B/Ge doped fibers.

Photosensitivity of B/Ge-doped fiber: The first fiber used to inscribe FBGs was a B/Ge doped Redfern™ photosensitive (PS) fiber. As described above, this type of fiber is known to result in type IIA gratings in which a negative index change occurs due to a relaxation of the induced stress along the axis. This type of grating is also more stable at high temperature compared to other type I UV inscribed gratings.

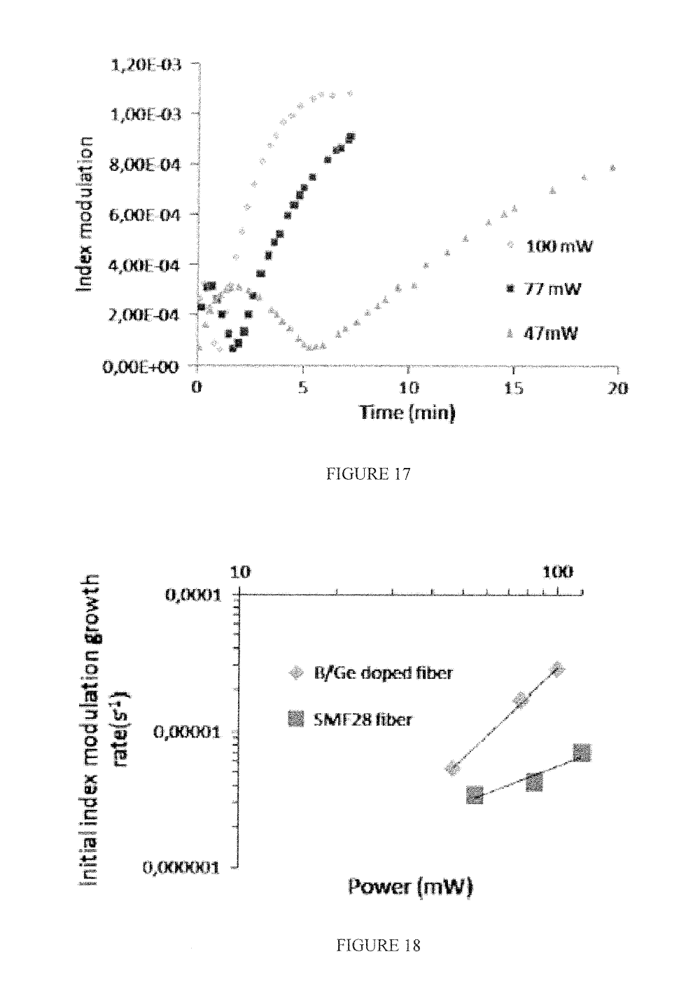

FIG. 17 shows the growth of the index modulation of a 2.7 mm long grating as a function of time for different incident 213 nm UV powers. By modeling the index modulation as proportional to I^{b}t, where I is the 213 mW UV power and t, the exposure time, it is possible to learn about the photosensitivity process via the exponent b. To determine the value of the exponent b, a log-log plot of the initial growth rate of the refractive index change vs the UV power is plotted as illustrated in FIG. 18. In this case, b is equal to 2.2, which is close to what would be expected from a two-photon absorption dominated process.

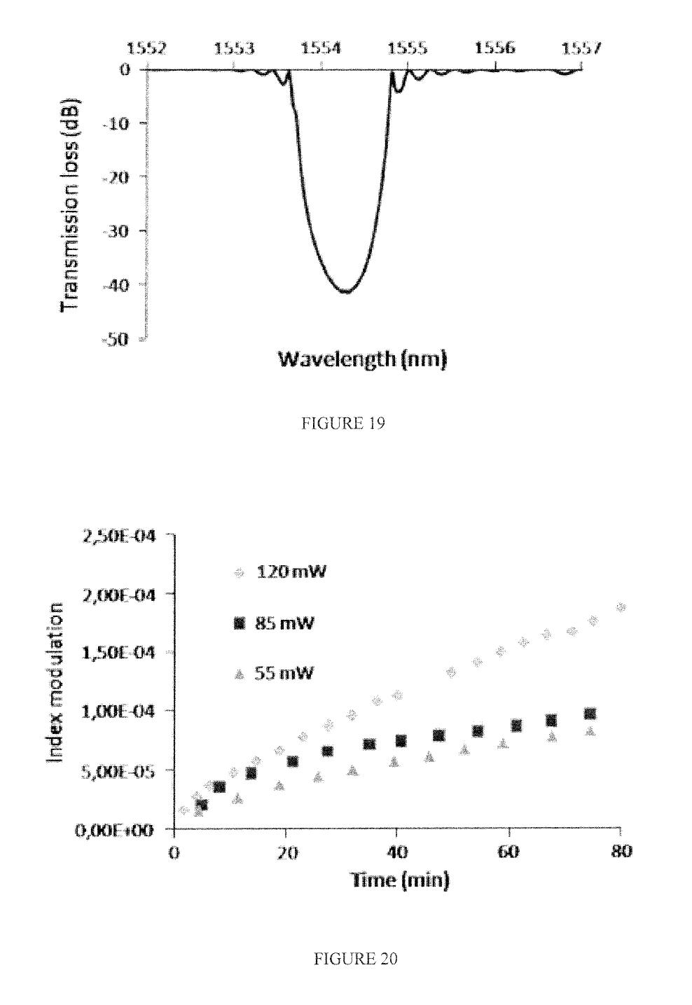

A type I grating is formed rapidly, reaching a Δn_{mod} of 3.24×10⁻⁴ and a transmission loss of −8.6 dB in only 22 seconds with 100 mW of incident 213 nm UV power. The grating bleaches and a type IIA grating starts to emerge after only 1 minute of exposure. This second type of grating is much stronger, reaching a Δn_{mod} of 1.1×10⁻³ with a transmission dip at the Bragg wavelength of −41.6 dB as shown on FIG. 19. The type IIA grating grows almost perfectly and linearly until it reaches saturation in around 5 minutes. The total index change Δnₜₒₜ, calculated from the Bragg wavelength shift and the index modulation, was found to be around 1.2×10⁻³.

These index change values are superior to what was previously reported in the prior art, and the time required for index saturation in the prior art experiment was around 2 hours. It was also demonstrated that the maximum transmission loss, for a grating of the same length as that presented in the present description, was only −14 dB. Therefore, the system of FIG. 3 is adequate for inscribing gratings in hydrogen-free fibers.

Photosensitivity of Corning™ SMF28™ fiber: Given the high photosensitivity obtained with the B/Ge doped fiber. FBGs were also written in standard hydrogen-free SMF28™ fiber. This type of fiber usually exhibits extremely poor photosensitivity.

FIG. 20 shows the growth of the index modulation of a 5 mm FBG written in an SMF28 fiber as a function of time for different incident power, i.e. 55 mW, 85 mW, and 120 mW UV powers. The evolution of the index change is much slower than that for the previous B/Ge fiber illustrated in FIG. 17. From the curves in FIG. 18, it is found that b is equal to 0.92, which is close to what is expected from single photon absorption.

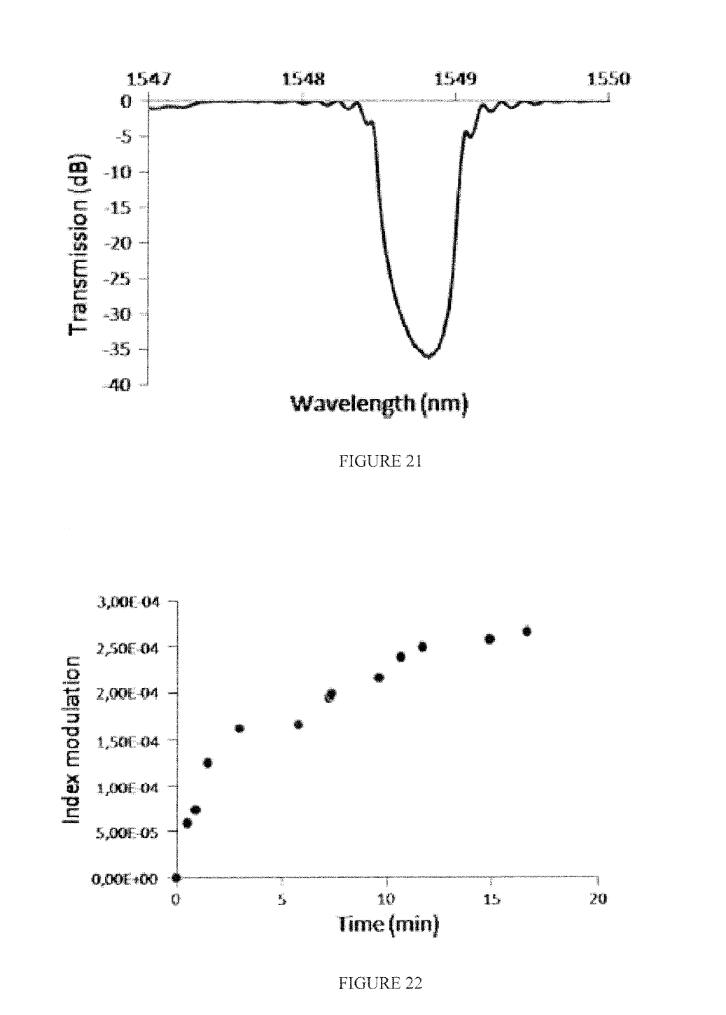

As illustrated in FIG. 21, the maximum transmission dip obtained at the end of 4.5 hours of exposure at 100 mW was −36.1 dB. The index modulation at saturation reaches Δn_{mod}=4.78×10⁻⁴, while the total index change reaches Δnₜₒₜ=1.06×10⁻³. These values are above what is obtained for the type I phase of the FBGs written in B/Ge doped fiber. It shows that it is possible to obtain high quality strong gratings in standard non-hydrogenated SMF28™ fiber. As a comparison, the same experiment was performed using 266 nm wavelength radiation (identical fabrication scheme, with the same repetition rate, 8 ns pulses and with an appropriate phase mask optimized for 266 nm) instead of 213 nm. Even with 300 mW of average power and after 20 minutes of exposure at 266 nm UV radiation, the reflectivity remained below 0.5%, i.e. 0.02 dB.

Photosensitivity of CorActive™ Erbium (Er) doped polarization maintaining fiber: The third type of fiber which was tested for FBG fabrication using 213 nm light was a CorActive™ Er-doped polarization maintaining fiber. While using 266 nm radiation, this fiber requires hydrogen-loading for strong writing FBGs therein.

FIG. 22 shows the growth of the index modulation of a 6.5 mm FBG written on a CorActive polarization maintaining fiber as a function of time. The fiber shows good photosensitivity, taking about 1000 secs to reach the maximum transmission loss of about −21.9 dB, as illustrated in FIG. 23. The index modulation reaches Δn_{mod}=2.45×10⁻⁴, while the total index change reaches Δnₜₒₜ=1.02×10⁻³. The two Bragg reflection wavelengths that can be observed in FIG. 23 are due to the birefringence of the polarization maintaining fiber. As for the SMF28™ fiber, no grating can be written effectively in this type of fiber using 266 nm, and photosensitivity with rare-earth dopants is reduced significantly even at 240 nm wavelength and strong gratings cannot substantially be generated without hydrogen loading.

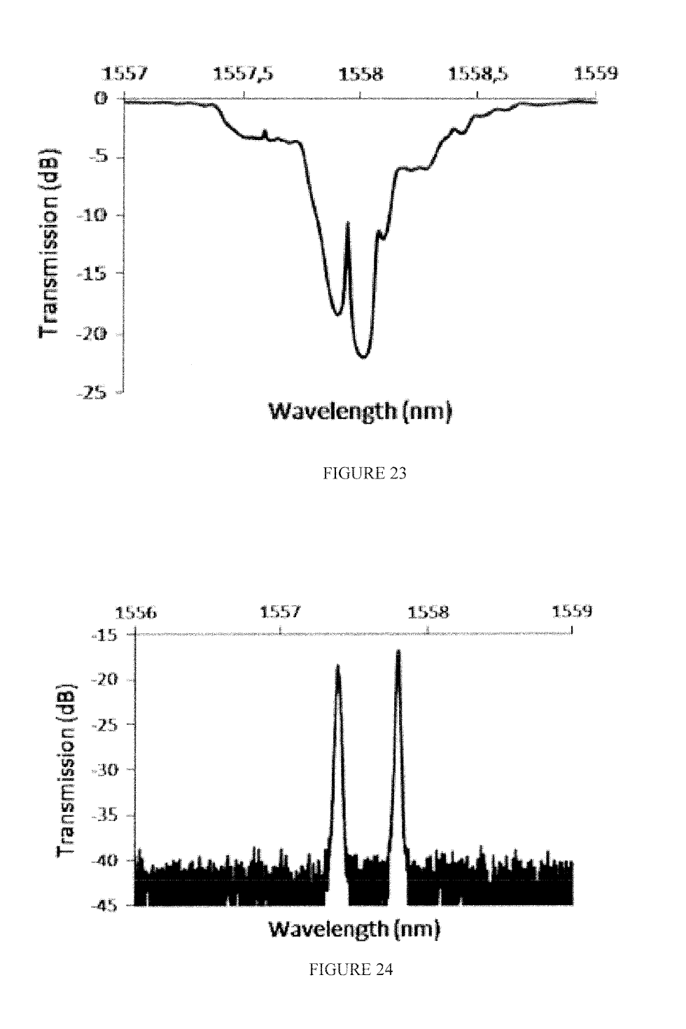

Two gratings separated by 20 cm were written into the polarization maintaining CorActive Er:doped fiber with 213 nm radiation to form a laser cavity. This cavity was pumped with a 976 nm wavelength laser and lasing was observed at a threshold of 12 mW. FIG. 24 shows the emission spectrum of this fiber laser. Two laser lines corresponding to the two Bragg wavelengths of the polarization maintaining fiber can be seen. The output power from this laser is low, as the gratings have a high reflectivity of about 99%. The birefringence in the fiber results in the two wavelengths being separated by about 0.25 nm, equivalent to a birefringence of 2.3×10⁻⁴. This demonstration shows that it is possible to obtain gratings in hydrogen-free erbium doped fiber for fiber lasers as well, without pre-sensitizing them with hydrogen.

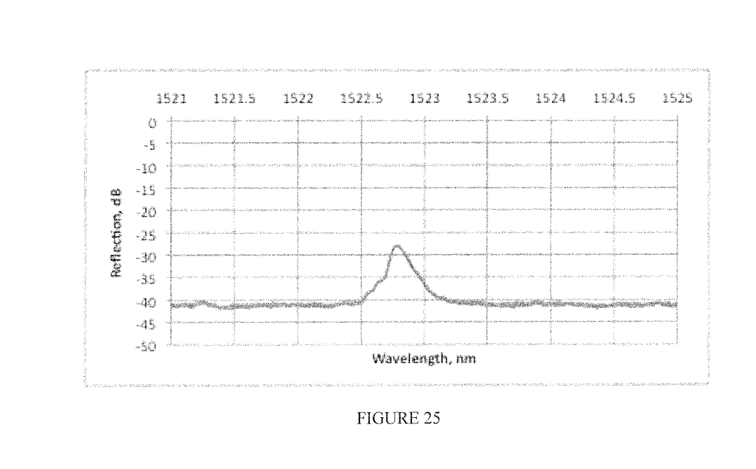

FIG. 25 illustrates the reflection versus wavelength for a 5 mm FBG inscribed in a pure silica fibre using a 213 nm source with a power of 90 mW and an exposure time of 1.5 hours. FIG. 25 shows that efficient FBGs may be inscribed in pure silica fibers using the system 40 of FIG. 3.

For the first time, the use of a ns pulse QS Nd:VO4 laser operating at its 5th harmonic wavelength has been shown to be highly effective for the fabrication of fiber Bragg gratings in several types of fiber, including the SMF28™, without the use of hydrogen. The intensity used is a fraction (about 3 MW-cm⁻² at 12.5 KHz, P_{average}˜100 mW) of the 200 MW-cm⁻² (at 10 Hz, P_{average}˜70 mW) reported in the prior art. We observe that the average power used in the present experiments is 1.4 times that reported in the prior art, in other words, of the same order of magnitude. Fast writing of FBGs with a response of about 20 times faster than in the prior art are obtained in the present experiments to reach type IIA saturation state in B/Ge doped fiber, with the intensities of about 100 times less.

The following may explain why the photosensitivity of the B/Ge doped fiber is greater with the lower intensity ns pulses used in the present experiments rather than with the high power ps pulses of the prior art.

Firstly, the difference may be partly attributable to the beam quality which may be highly irregular with large fluctuations in the peak power due to the low repetition rate ps pulsed laser of the prior art. Consequently hot spots possibly drove the fiber into a type II grating in different regions of the fiber non-uniformly. With the high repetition ns-pulsed laser of FIG. 3, the peak power is low and the beam is highly uniform and thus does not drive the fiber into a type II regime in different sections of the fiber, providing a more uniform index change.

Secondly, although it was shown that two-photon absorption is the dominant process for B/Ge doped fiber, single-photon absorption may also play an important role. This would explain the lack of considerable improvement with the high peak-powers used in the prior art compared to the low intensities used in the present experiments. Many processes contribute to photosensitivity in B/Ge doped fiber. Compaction and color centers formation are responsible for the positive index change (type I), while stress relaxation between the core and the cladding is responsible for the negative index change (type IIA). The greater contribution of the single-photon absorption in the case of 7 ns pulses is supported by the final total index change, which stays relatively high (about 10⁻³) instead of returning to small values as was reported for 150 ps pulses (about 10⁻⁴) in the prior art. There is significant background absorption at 213 nm, of the order of 40 dB-mm⁻¹ (about 92 cm⁻¹, which increases with exposure at 248 nm radiation), although this is lower than in the 240 nm band in Ge doped-fibers. This means that there is probably a role played by a short-lived defect state induced by single photons at 213 nm, and that the 7 ns pulses used in the present experiments may have a pulse width longer than the lifetime of the short-lived defects, which allows to permanently change the absorption state more efficiently, leading to faster refractive index changes compared to the 150 ps pulses used in the prior art. Given the significant single-photon absorption, we believe that 213 nm radiation induces color centers, which take a longer time to form than the 150 ps pulse duration. Photosensitivity is more likely due in part to the germanium oxygen deficiency centers (GODC) with a peak absorption at 6 eV, and Ge′ centers with the longer ns pulses of the present description. As the absorption at 213 nm increases with time, it is possible that this becomes a cascaded process. It is also possible that stress relaxation and compaction may benefit from color centers formation.

Contrary to what was previously reported in the prior art, it was demonstrated in the present description that photosensitivity of low Ge fiber such as SMF28™ is dominated by single photon absorption. Although it required a long exposure time (about 4.5 hours), a total index change of about 1×10⁻³ was induced, which is similar to what can be obtained using a high power 193 nm laser. There is a higher probability for two-photon-contribution at high intensities with low Ge content fiber such as SMF28™ at a wavelength of 193 nm, while for high Ge content fiber, the single-photon contribution is greater. It is interesting to note that 213 nm and 193 nm photosensitivity have opposite behaviors depending on the type of fiber. As previously stated, a single photon process is usually associated with color center formation through the germanium oxygen deficiency centers (GODC), which have peak absorptions at 193 nm and 242 nm. The GODC absorption band also absorbs 213 nm light moderately, having an absorption coefficient approximately ⅕th that of 193 nm and ⅓rd of 242 nm. Other defects might also play a role in the large index modulation observed, such as Ge(2) centers that have an absorption peak centered at 213 nm. An interesting observation was made after approximately 30 minutes of exposition as the photoluminescence changes from the commonly observed blue to a distinct bright pink. This could originate from induced non-bridging oxygen hole centers (NBOHC), which are known to show photoluminescence at 650 nm.

While the present description refers to 7 ns pulses at 213 nm, it should be understood that other values for the pulse width are possible. For example, the pulse width may be comprised between 7 ns and 12 ns. In another example, the pulse width is at least equal to 1 ns. In a further embodiment, the light source emits a CW light, which means that the light source emits a single pulse having a long width. For example, the pulse width may be 1 microsecond, 3 seconds, 2 minutes, 1 hour, or the like. The amplitude of the pulse may vary along the width, i.e. as a function of time. Alternatively, the amplitude of the pulse may be substantially constant along the pulse width. It should also be understood that the repetition rate for the pulses may be chosen so that the pulsed light substantially correspond to a CW light.

While FBGs having a reflectivity as high as 98% can be achieved in a hydrogen-free SMF28™ using a 213 nm pulsed light of which the pulses have a width adapted to modify the refractive index of the optical fiber via a single-photon absorption process, experiments have demonstrated that a reflectivity of less than 1% can only be achieved in this fiber using a 244 nm pulsed light. Therefore, one can assume that great reflectivity FBGs may be obtained using a pulsed light having a wavelength within a range around 213 nm and comprising pulses of which the width adapted to modify the refractive index of the optical fiber via a single-photon absorption process.

In one embodiment, the wavelength of the pulsed light is comprised between about 213 nm minus about 5% and 213 nm plus about 13%, i.e. between about 203 nm and about 240 nm. In another embodiment, the wavelength of the pulsed light is comprised between about 210 nm and about 230 nm. In another embodiment, the wavelength of the pulsed light is comprised between about 212 nm and about 214 nm. In yet another embodiment, the wavelength of the pulsed light is comprised between about 221 nm and about 223 nm. In a further embodiment, the wavelength of the pulsed light is comprised between about 229 nm and about 231 nm.

The embodiments described above are intended to be exemplary only. The scope of the invention is therefore intended to be limited solely by the scope of the appended claims.

I/we claim:

1. A method for inscribing a grating into an optical waveguide, the method comprising:
generating a light beam having a wavelength comprised between about 203 nm and about 240 nm, the light beam comprising at least one output pulse having a pulse width of an order of magnitude of nanoseconds (10⁻⁹);
directing the light beam onto an optical waveguide transversely to a propagation axis thereof; and
changing an index of refraction of the optical waveguide as a function of an intensity and a duration of the light beam.

2. The method of claim 1, wherein directing the light beam comprises directing the light beam onto a hydrogen-free optical waveguide.

3. The method of claim 1, wherein generating a light beam comprises generating the light beam with a wavelength comprised between about 212 nm and about 214 nm.

4. The method of claim 1, wherein generating a light beam comprises generating the at least one pulse with a pulse width comprised between about 7 nanoseconds and about 12 nanoseconds.

5. The method of claim 1, wherein directing the light beam comprises focusing the light beam onto the optical waveguide.

6. The method of claim 5, wherein focusing the light beam comprises propagating the light beam through at least one lens.

7. The method of claim 1, wherein directing the light beam comprises interfering the light beam in order to generate an optical interference pattern and exposing the optical waveguide to the optical interference pattern.

8. The method of claim 1, wherein directing a light beam comprises directing the light beam onto a single-mode hydrogen-free optical fiber.

9. The method of claim 1, wherein directing a light beam comprises directing the light beam onto a germanium-free optical waveguide.

10. A method for inscribing a grating into an optical waveguide, the method comprising:
generating a light beam having a wavelength comprised between about 203 nm and about 240 nm, the light beam comprising one of a continuous wave output beam and at least one output pulse having a pulse width of an order of magnitude of nanoseconds (10⁻⁹);
directing the light beam onto an optical waveguide transversely to a propagation axis thereof; and
changing an index of refraction of the optical waveguide as a function of an intensity and a duration of the light beam.

11. A system for inscribing a grating into an optical waveguide, the system comprising:
a pulsed light source for generating and emitting an output beam having a wavelength comprised between about 203 nm and about 240 nm, the output beam comprising at least one output pulse having a pulse width of an order of magnitude of nanoseconds (10⁻⁹); and
a directing device for directing the output beam onto an optical waveguide transversely to a propagation axis thereof and changing an index of refraction of the optical waveguide as a function of an intensity and a duration of the output beam.

12. The system of claim 11, wherein the pulsed light source is adapted for generating the output beam with a wavelength comprised between about 212 nm and about 214 nm.

13. The system of claim 11, wherein the pulsed light source is adapted for generating the at least one pulse with a pulse width comprised between about 7 nanoseconds and about 12 nanoseconds.

14. The system of claim 11, wherein the directing device comprises a focusing device for focusing the pulsed light onto the optical waveguide.

15. The system of claim 14, wherein the focusing device comprises at least one lens.

16. The system of claim 11, wherein the directing device comprises an interference pattern generator adapted to generate an optical interference pattern and expose the optical waveguide to the optical interference pattern.

17. The system of claim 11, wherein the pulsed light source comprises a Q-Switched, optically pumped, fifth harmonic laser source.

18. An optical filter comprising an optical waveguide extending along a propagation axis thereof, the optical waveguide having a grating formed therein causing an index of refraction to vary along the propagation axis, the grating having been formed by at least one pulse having a wavelength comprised between about 203 nm and about 240 nm and a pulse width of an order of magnitude of nanoseconds (10⁻⁹).

19. The optical filter of claim 18, wherein the grating is a Fiber Bragg Grating.

20. The optical filter of claim 18, wherein the optical waveguide is a hydrogen-free optical fiber.
